(19) United States
(12) Patent Application Publication
(10) Pub. No.: US 2007/0153773 A1
(43) Pub. Date: Jul. 5, 2007

(54) Communication control unit

(76) Inventors: Tatsuhiko Miyata, Kokubunji (JP); Hiroshi Kodaka, Chigasaki (JP); Mariko Yamada, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/503,232

(22) Filed: Aug. 14, 2006

(30) Foreign Application Priority Data
Jan. 4, 2006 (JP) 2006-000023

(51) Int. Cl. H04L 12/66

(52) U.S. Cl. 370/352

(57) ABSTRACT

An extension telephone using an ordinary telephone circuit cannot be coordinated with a data terminal connected by an IP network. An extension telephone using an ordinary telephone circuit has none of the convenient functions of an IP telephone, such as implementing outgoing/incoming call data management and telephone book management on a PC. A telephone terminal using an ordinary telephone circuit and a data terminal in an IP network can however be coordinated by reflecting telephone calls and call signal details in an IP network by means of a telephone adapter which can send and receive IP network data and call signals using IP network data as a trigger. A user of an ordinary telephone system can easily coordinate a telephone with a data terminal, and even if there is a “modernization time lag” between the data system and telephone system, or the IP telephone system is introduced gradually, an environment is created whereby all users can make maximum use of coordination between the data system and telephone system.

### CLAIM OF PRIORITY

The present application claims priority from Japanese application JP 2006-000023 filed on Jan. 4, 2006, the content of which is hereby incorporated by reference into this application.

### FIELD OF THE INVENTION

This invention relates to acquisition of a telephone status, and to a telephone setting method.

### BACKGROUND OF THE INVENTION

In recent years, a great deal of research has been carried out techniques for determining the status of users in a communications network using a concept called “presence”. As its name implies, “presence” means the “existence” of each user for the purpose of notifying other users, and includes various types of data, specifically the current position, current status or other data indicating the existence of a user or communication device. By notifying this “presence” to other users in real time, other users can be made aware of their current status, for example, to make decisions such as “since the other party is busy I won't try to call”, or “since the other party is out, let's connect to the other party's mobile phone”, etc.

The concept and communication technique of “presence” were developed from IM (Instant Messaging). IM and the concept of presence are being standardized mainly by the impp (Instant Messaging and Presence Protocol) workgroup of the IETF (Internet Engineering Task Force) (IETF RFC2778 and IETF RFC2779). Specific presence communication techniques are also being discussed and standardized by various IETF workgroups based on the concept specified by impp. For example, in SIMPLE (SIP for Instant Messaging and Presence Leveraging Extensions) of the IETF, a method for sending and receiving presence data using SIP (Session Initiation Protocol) is now being studied.

In company extension networks, telephone systems are constructed using PBX (Private Branch exchanges) which perform exchange of call signals and have various telephone functions such as proxy response capability and hold functions, and internal telephones. Signals between the PBX and telephone terminals are exchanged via an ISDN (Integrated Service Digital Network) specified by ITU-T (International Telecommunication Union Telecommunication Standardization Sector), an international organization which is responsible for standardization of communications), or CCITT (Consultative Committee for International Telegraph and Telephone), its predecessor, by analog signals, or by signaling systems developed by each PBX vendor based on these specifications. Each user can make use of various PBX functions such as call picking (proxy response) or call park (hold) by performing setup or user specifications from a telephone terminal.

In an ordinary company office, each employee has a data terminal such as a personal computer to implement the presence function, and an extension telephone to implement the extension function, on his desk. The data terminal is connected to an IP (Internet Protocol) network via an Ethernet (registered trademark) or the like by an RJ-45 connector, whereas the extension telephone is connected to the telephone network by an RJ-11 connector, and these connections lead to different destinations by different routes. FIG. 20 shows an example of the network connections in an ordinary office. In FIG. 20, User A shown by 41 and User B shown by 42 have their own data terminals 43, 47 and telephone terminals 44, 48 on desks 46, 50. The data terminal is connected to a presence send-receive server 52 of a data center 53 via an IP network 51 such as an in-house LAN so as to implement a presence send-receive function. On the other hand, the telephone terminal is connected to a PBX 55 installed in the data center 53 via a telephone extension network 54 so as to implement a telephone function.

In recent years, there has also been considerable research on VoIP (Voice over IP) technology in which the telephone network is replaced by an IP network. Various consumer-oriented IP telephone services are being developed by communication carriers or ISP (Internet Service Providers), and company-oriented IP extension phone systems are being developed by PBX vendors using IP-PBX. One of these IP telephone communications techniques is being standardized as a SIP protocol mainly by the SIP workgroup of IETF. Even in the case of IP phone, the functions of an earlier type of company extension network can be implemented by IP-PBX, and these functions can be set and user-specified not only from an IP telephone terminal, but also from a data terminal such as a personal computer. This is because data terminals, IP phone terminals and IP-PBX are connected via the same IP network.

When constructing a company-oriented IP phone system, the IP extension phone technique and presence technique discussed above are often considered at the same time. This is because the question of whether or not another party can be called can be determined by considering “IP phone status” as presence data, and notifying other users of this status. Since IP phone uses an IP network as data transmission route in the same way as the presence technique, there is a high affinity between these two techniques.

FIG. 19 shows an example of the network connections in an ordinary company office which introduced IP extension phones. In FIG. 19, the telephone terminals 44, 48 shown in FIG. 20 are replaced by IP phone terminals 301, 302, respectively, these IP phone terminals being connected to the IP network 51.

In other words, the data terminal and IP phone terminal are connected to the same IP network via an Ethernet (registered trademark) using a RJ-45 connector. PBX is also replaced by an IP-PBX 303 which is compatible with the IP network, and is connected to the IP network 51 in the same way as the IP phone terminal. In such a network arrangement, it is relatively easy for the presence function to be coordinated with the IP extension telephone function. Since IP-PBX manages the communication status of each IP extension telephone terminal, it can be determined whether, for example, the IP phone terminal 301 on the desk of User A is “busy” or “on hold.” Therefore, if the IP-PBX notifies this fact to a presence send-receive server 52 via the IP network 51, the data terminal can be notified of the presence data from the presence send-receive server 52 via the same IP network 51. As to the specific method for doing this, JP-A No. 2005-020652 gives a detailed description. Also, instead of the IP-PBX 303, the IP phone terminals such as 301 or 302 can send data specifying whether or not they are busy. The IP phone terminals are connected to the IP network 51, and they can register their own status in the presence send-receive server 52 via the network. It is also possible for the IP phone terminals to access the presence send-receive server 52, and to verify other users' presence data.

### SUMMARY OF THE INVENTION

In the company office network connections of the prior art shown by FIG. 20, data terminals are connected to a network which is totally physically different from that of telephone terminals, so the two cannot be coordinated with each other. In general, IP phones are introduced on a gradual basis. There is therefore a service level gap between users who have introduced IP phone, and those who have not yet done so. Moreover, an advanced data system such as the presence function and the IP phone system are not necessarily introduced simultaneously. In such a case, although the data system may be state-of-the-art, an ultramodern coordination system cannot be used since the telephone system is of an earlier type.

By fitting an adapter to an ordinary telephone, a coordinated system identical to the kind of system that results from introducing IP telephones can be implemented by an earlier type of extension telephone system. This adapter has a function which allows coordination between the telephone system and a data system even if the telephones are not converted to IP phones. The adapter is installed by connecting to the telephone line which connects the PBX with the telephones. In almost all cases, it is installed just next to the telephone terminal on the desk where the telephone terminal is installed. In addition to a connection port to the telephone line, this device connects to a data terminal, such as a personal computer, using a data transmission path such as a USB (Universal Serial Bus). It analyzes call signals from the telephone line, and instructs a data terminal as to what action to take with a data server such as a presence server according to the signal details. Conversely, according to directions from the data terminal, it performs actions such as generating call signals, setting the PBX and ringing the bell of the telephone terminal. Instead of connecting the telephone line and checking the call signal, the status of the telephone terminal on the desk may be verified using another method, e.g., the motion of the receiver may be monitored by a sensor which detects the picking up and lowering of the receiver, and checking the call status. Further, the adapter may not connect to the data terminal, but may instead be directly connected to the IP network and data sending/receiving performed with a data server like a presence server.

Even a user who has not introduced an IP phone system can coordinate with a data system such as a presence function, and perform telephone function settings via a data terminal such as a personal computer. When a company introduces IP phones gradually, even if a gap occurs in the timing when the data system and the IP phone system are introduced, each user can use a data system coordination function at the same level as that of the IP phones.

### BRIEF DESCRIPTION OF THE DRAWINGS

FIG. 1 is a telephone adapter installation diagram according to the invention;

FIG. 2 is a telephone adapter function block diagram according to the invention;

FIG. 3 is a network connection diagram in the device of the invention;

FIG. 4 is a network connection diagram in the device of the invention;

FIG. 5 is a flow chart diagram in the device of the invention;

FIG. 6 is a flow chart diagram in the device of the invention;

FIG. 7 is a sequence chart showing an operating example of the device of the invention;

FIG. 8 is a sequence diagram showing a call signaling example using the device of the invention;

FIG. 9 is an example of a message issued by the device of the invention;

FIG. 10 is a diagram of a telephone adapter according to the invention;

FIG. 11 is a sequence diagram showing an operating example of the device of the invention;

FIG. 12 is a sequence diagram showing an operating example of the device of the invention, and a display example;

FIG. 13 is a sequence diagram showing an operating example of the device of the invention, and a display example;

FIG. 14 is a sequence diagram showing an operating example of the device of the invention, and a display example;

FIG. 15 is a sequence diagram showing an operating example of the device of the invention;

FIG. 16 is a sequence diagram showing an operating example of the device of the invention;

FIG. 17 is a sequence diagram showing an operating example of the device of the invention, and a display example;

FIG. 18 is a sequence diagram showing an operating example of the device of the invention, and a display example;

FIG. 19 is an example of network connections between an ordinary telephone terminal and an IP telephone terminal; and

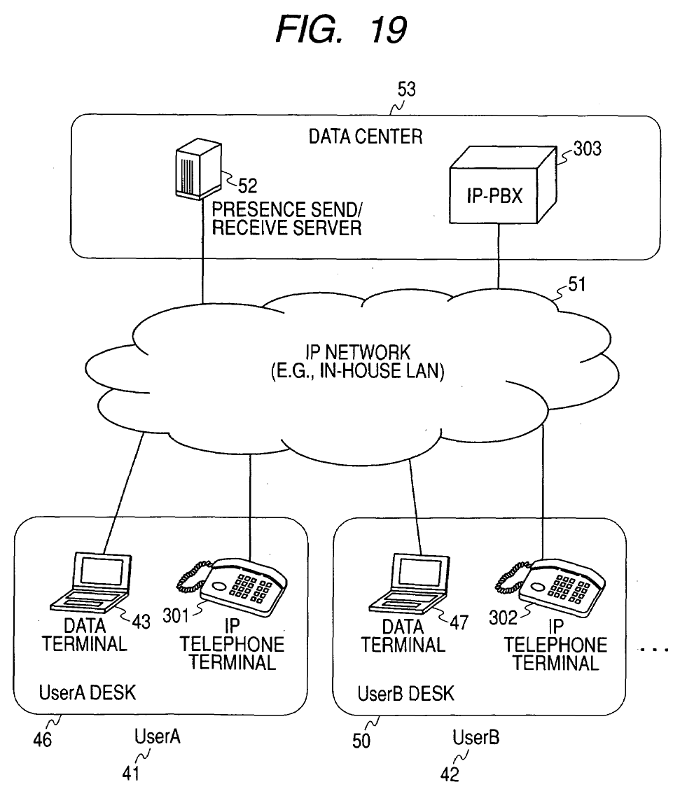

FIG. 20 is an example of network connections between an ordinary data terminal and a telephone terminal.

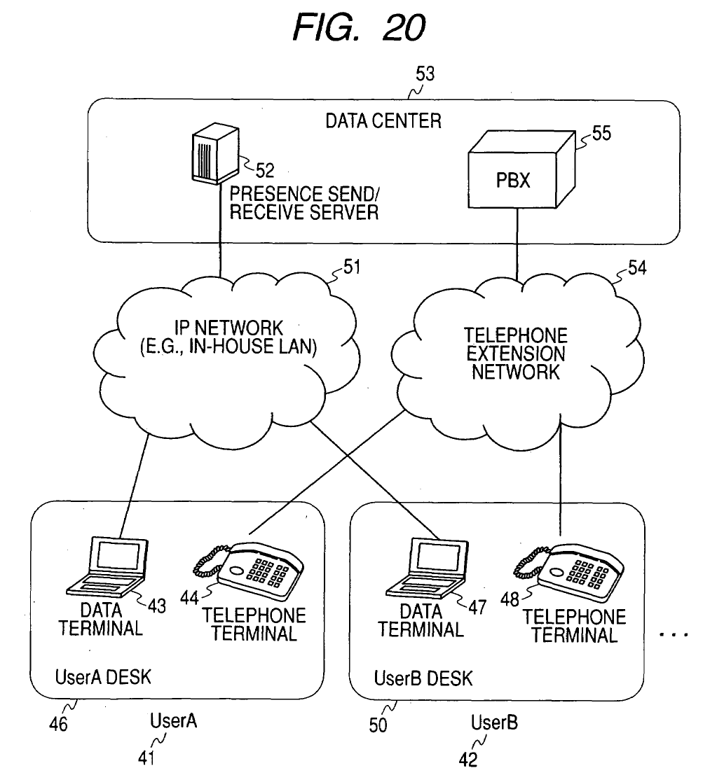

### DESCRIPTION OF THE PREFERRED EMBODIMENTS

### Embodiment 1

In this embodiment, first, the physical construction, logical construction and operational overview of the telephone adapter of the invention, and an actual example of the network connections of a company office using this adapter, will be described. Next, referring to flowcharts, specific examples of the usage of the telephone adapter of the invention, PC displays and messages, will be given.

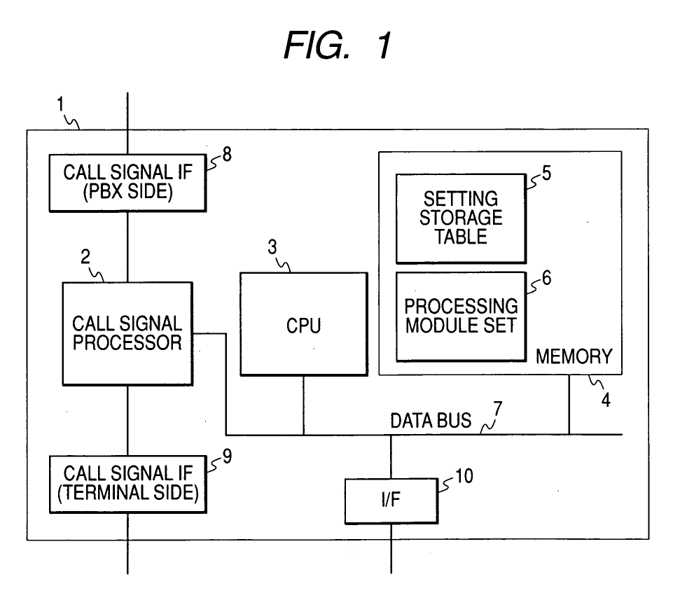

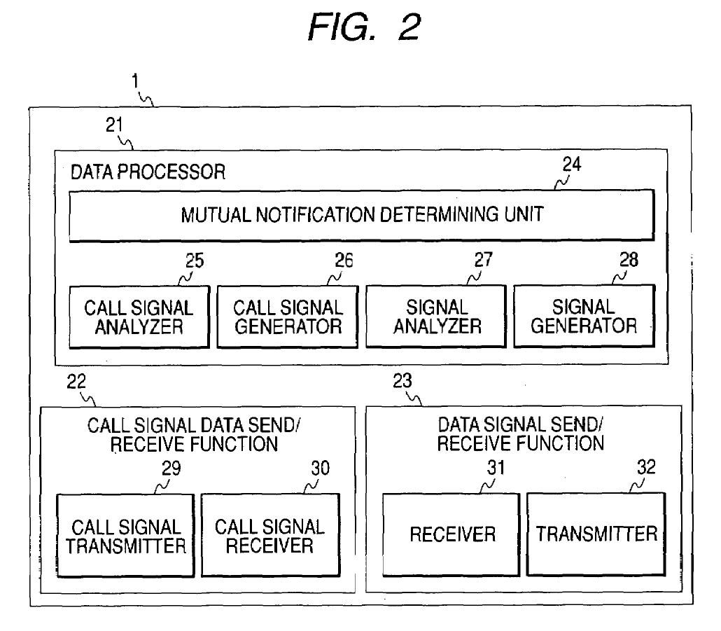

FIG. 1 shows the physical configuration of the telephone adapter of the invention. FIG. 2 shows a functional block diagram of the telephone adapter of the invention. The functional block diagram of FIG. 2 is a diagram showing the logical functions, but it will be understood that each functional block can be implemented either by software or hardware.

If the functional block shown in FIG. 2 is implemented by software, the processing contents are stored in a processing module set 6 in a memory 4 of FIG. 1, and when a function is executed, a CPU 3 calls these data via a data bus 7, and performs processing according to the procedure. The data required for each processing is stored in a setting storage table 5 of the memory 4, and if required, read/write to and from the table is performed via the data bus 7. In this embodiment, an example will be described where call signal processing is performed by hardware in a call signal processing unit 2, and signal processing with respect to the IP network is performed by software.

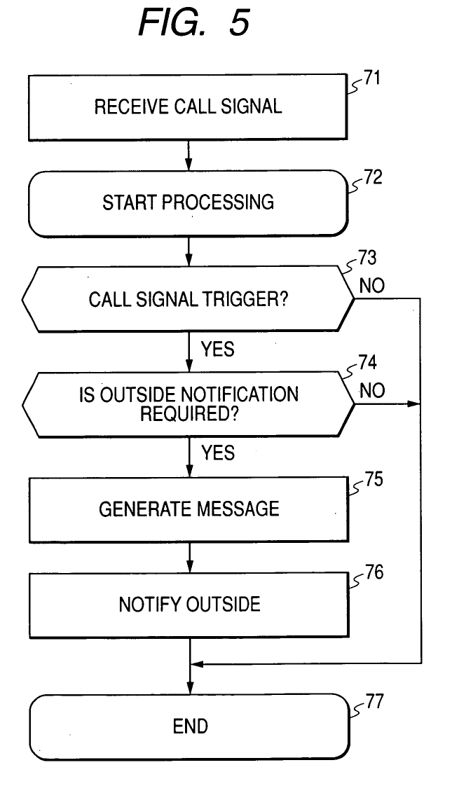

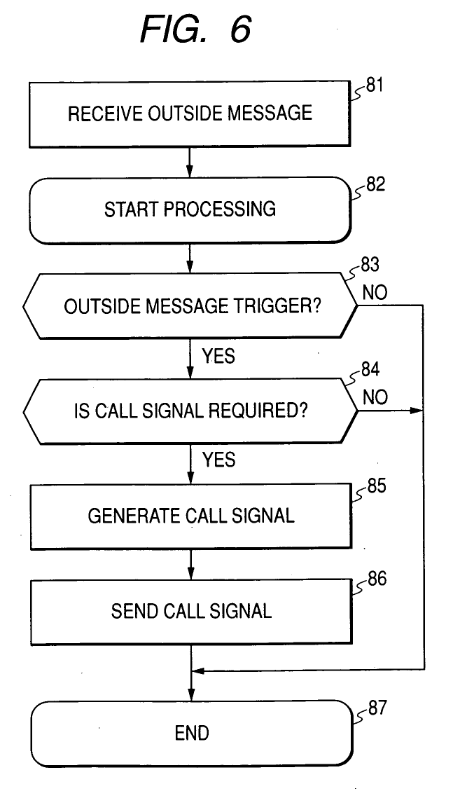

FIGS. 5, 6 are operational flow charts of the telephone adapter of the invention. An operational outline of the adapter will now be described using the block diagrams of FIGS. 1, 2. The telephone adapter of the invention has two operating patterns. In one pattern, the adapter receives a call signal, and sends a signal to an interface with a data terminal or the IP network side according to the contents. In the other pattern, it receives a signal from the interface to the data terminal or the IP network side, and sends a call signal according to the contents. FIG. 5 illustrates the former operation and FIG. 6 illustrates the latter operation.

First, the processing of FIG. 5 will be described. When, in a step 71 of FIG. 5, the telephone adapter of the invention receives a call signal in a call signal receiving unit 30 of a call signal data send-receive function 22 of FIG. 2, which is in the call signal processing unit 2 of the call signal IF (PBX side) 8 or call signal IF (terminal side) 9, in a step 72, processing is started. Next, in a step 73, the call signal analysis unit 25 of the call signal processing unit 2 checks whether the received call signal is a telephone adapter trigger.

If it is determined that the signal is not a trigger, in a step 77, processing is terminated. The received call signal is then transmitted as it is via the call signal IF(PBX side) 8 or call signal IF(terminal side) 9 from a call signal transmitting unit 29 of the call signal send-receive function 22 in the call signal processing unit 2. If the call signal is received from the call signal IF 8 on the PBX side, the call signal is sent from the call signal IF 9 on the terminal side. In the reverse case, the send-receive IF are reversed. Even if the call signal is a telephone adapter trigger, if processing is terminated in the step 77 after the telephone adapter has functioned, the call signal is sent as it is as described above.

If it is determined in the step 73 that the call signal is a telephone adapter trigger, the call signal analysis unit 25 in the call signal processing unit 2 stores the contents of the signal in the setting storage table 5 of the memory 4 via the data bus 7 of FIG. 1, and the routine proceeds to a step 74.

In the step 74, a mutual notification determining unit 24 in a data processing unit 21 of FIG. 1 performs further signal analysis. The mutual notification processing unit 24 extracts the call signal which has just been stored in the setting storage table 5 of the memory 4, and by analyzing the signal, determines whether or not it is required to notify other IF. If it is determined that it is not required, the routine proceeds to the step 77 and is terminated. If it is determined that it is required, the routine proceeds to a step 75.

In the step 75, a message notified by the signal generator 28 is generated. Next, in a step 76, a transmitter 32 of the data system signal send-receive unit 23 notifies the message to outside, and in the step 77, the routine is terminated.

Next, the routine of FIG. 6 will be described. When, in a step 81 of FIG. 6, the receiving unit 31 of the data system signal send-receive function 23 of FIG. 2 receives a signal from a data terminal such as a personal computer or an IP network, from an IF 10 of FIG. 1, in a step 82, the telephone adapter of the invention starts processing. Next, in a step 83, the signal analysis unit 27 of the data processing unit 21 of FIG. 2 checks whether the signal is a telephone adapter trigger. If it is determined that it is not a trigger, processing proceeds to a step 87 and is then terminated. If it is determined that the signal is a trigger, the signal is stored in the memory 4 of FIG. 1 and the setting storage table 5, and the routine proceeds to a step 84.

In the step 84, the mutual notification determining unit 27 in the data processing unit 21 of FIG. 2 reads the signal which has just been stored in the setting storage table 5, and performs further signal analysis. The mutual notification processing unit 24 determines whether or not it is required to notify the signal received by the call signal IF, and if it is determined that it is not required, the routine proceeds to a step 87 and processing is terminated. If it is determined that it is required, the routine proceeds to a step 85.

In the step 85, the call signal generation unit 26 in the data processing unit 21 of FIG. 2 generates a call signal to be notified to PBX or telephone terminal. Next, in a step 86, the call signal transmitting unit 29 which is in the call signal data send-receive function 22 of FIG. 1, sends the call signal from the call signal IF (PBX side) 8 or the call signal IF (terminal side) 9 of FIG. 1, and in a step 87, processing is terminated.

Hence, when the telephone adapter of the invention receives a signal from the outside, it performs four cycles, i.e., “signal reception”, “contents analysis”, “notification required/not required determination”, and “notification”. The type of signal received and transmitted, the analysis method, and the details of whether notification is required/not required, are not particularly limited.

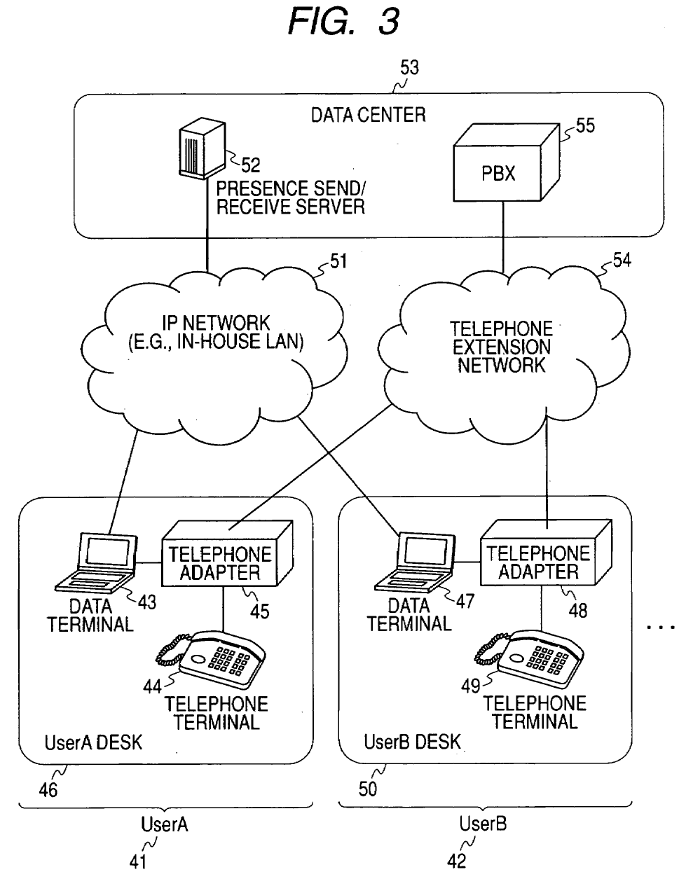

FIG. 3 is a drawing showing an example of the network connections when the telephone adapter of the invention is installed in an actual company office.

User A shown by 41 and User B shown by 42 of this example use one of the most advanced data systems, and the telephone system consists of the telephone network and a PBX. For example, the telephone adapter used by User A 41 is disposed as shown by 45 just next to a telephone terminal 44 on the desk 46 of User A. The telephone adapter 45, in addition to the telephone terminal 44, is connected to the PBX 55 in the data center 53 via a telephone extension network 54 by a telephone line. A signal line such as USB also connects to the data terminal 43. The data terminal 43 is connected to the IP network 51 via an Ethernet (registered trademark) of type RJ-45 or the like. This is identical for the desk 42 of User B. The telephone adapter of the invention is installed in this configuration.

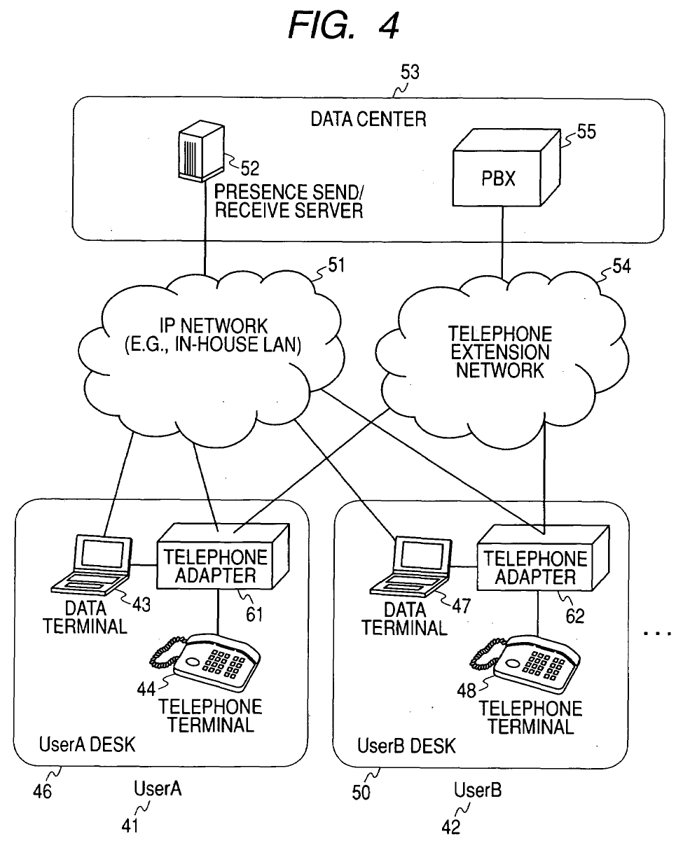

FIG. 4 shows another example of telephone adapter installation.

In this installation example, the part which is different from FIG. 3 is that a telephone adapter 61 of, for example, User A 41 is not connected to the data terminal 43. The telephone adapter 61 has an Ethernet (registered trademark) connection port of type RJ-45, and can be connected to the IP network 51 directly. This is identical for User B 42. Hence, provided that the telephone adapter of the invention functions as required, it can be connected to the data system in any way desired.

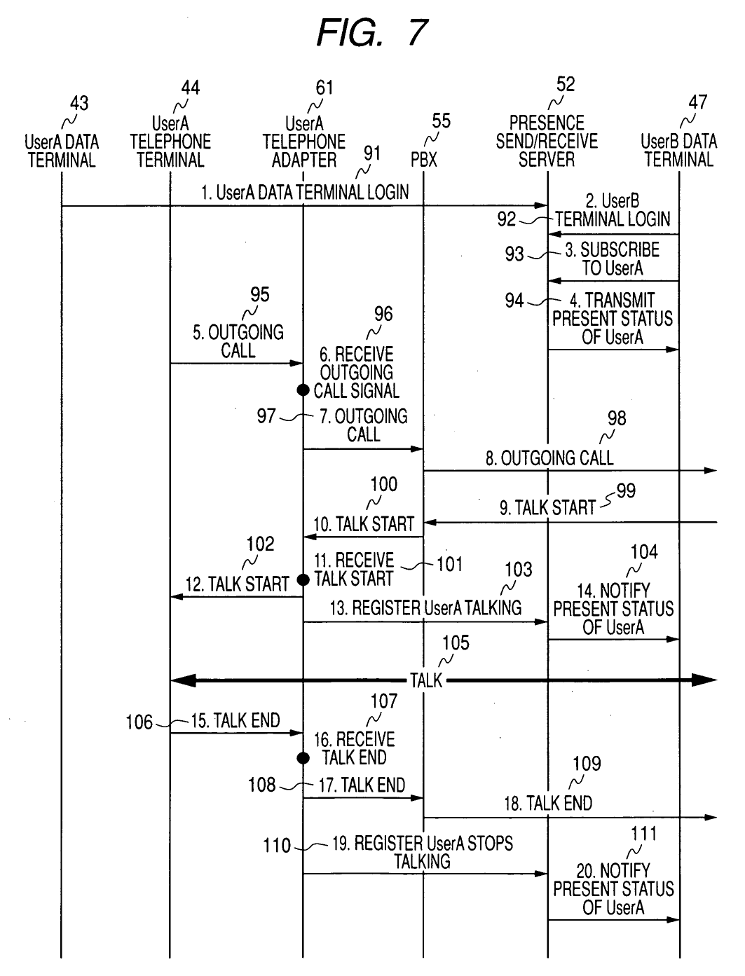

FIG. 7 is a sequence diagram showing an operating example of the telephone adapter of the invention. This example applies to the network connections shown in FIG. 4. In the example of FIG. 7, while User B is looking at presence data for User A, User A makes an outgoing call to a user other than User B, and starts talking. In this example, the telephone adapter notifies the presence send-receive server 52, so User B receives a notification to the effect that User A is talking. The situation is the same when User A finishes his telephone call, and the data is notified to User B from the presence send-receive server 52 as presence data. The details of this example will now be described referring to sequence diagrams.

In FIG. 7, first, in steps 91, 92, the data terminal 43 of User A and the data terminal 47 of User B log in to the presence send-receive server 52.

In a step 93, the data terminal 47 of User B, to receive current presence data and receive notification changing presence data for User A, sends a message showing he wants to subscribe to User A, to the presence send-receive server 52. In a step 94, the subscription to User A is accepted and the current presence data for User A is transmitted to the data terminal 47 of User B from the presence send-receive server 52. Thus, each user transmits a subscription request message to the presence send-receive server 52 so as to see other users' presence data.

Next, in a step 95, assume that User A makes a telephone call to another user from his own telephone terminal 44. At this time, in a step 96, the telephone adapter 61 on the desk of User A receives a call signal. Upon receiving this signal, the telephone adapter starts processing according to the flow chart shown in FIG. 5. In this example, the call signals used as triggers for the telephone adapter are set as “the time when a call starts”, and “the time when a call ends.” Hence, in a step 73 of FIG. 5, it is determined as “N” and in a step 77, processing is terminated. The call signal transmitted on that occasion is transmitted to the PBX 55 in a step 97 of FIG. 7.

Next, in a step 98, the signal is sent to the destination user's telephone terminal from the PBX, and in a step 99, when the destination user picks ups the receiver, a response thereto is transmitted to the PBX 55. In a step 100, the signal is transmitted to the telephone adapter 61 of User A via the PBX 55.

In a step 101, the telephone adapter 61 receives the signal, and operates again according to the flow chart shown in FIG. 5. However, at this time, since this signal is a signal used as a trigger for the telephone adapter, in a step 73 of FIG. 5, the routine proceeds to the following step, and in a step 74, UserA Telephone Adapter determine to make a notification to start talking. Next, in steps 75, 76, by generating and sending a message, a message is sent to the presence send-receive server 52 as in a step 103 of FIG. 7.

However, this example shows the operation of the network connections of FIG. 4. In the case of the connections shown in FIG. 3, the telephone adapter 45 does not transmit a message to the presence data send-receive server 52 directly, but first, instructs a message to be sent to the data terminal 43 of User A via a data signal line such as USB, and in practice, the data terminal 43 of User A registers presence data in the presence data send-receive server 52.

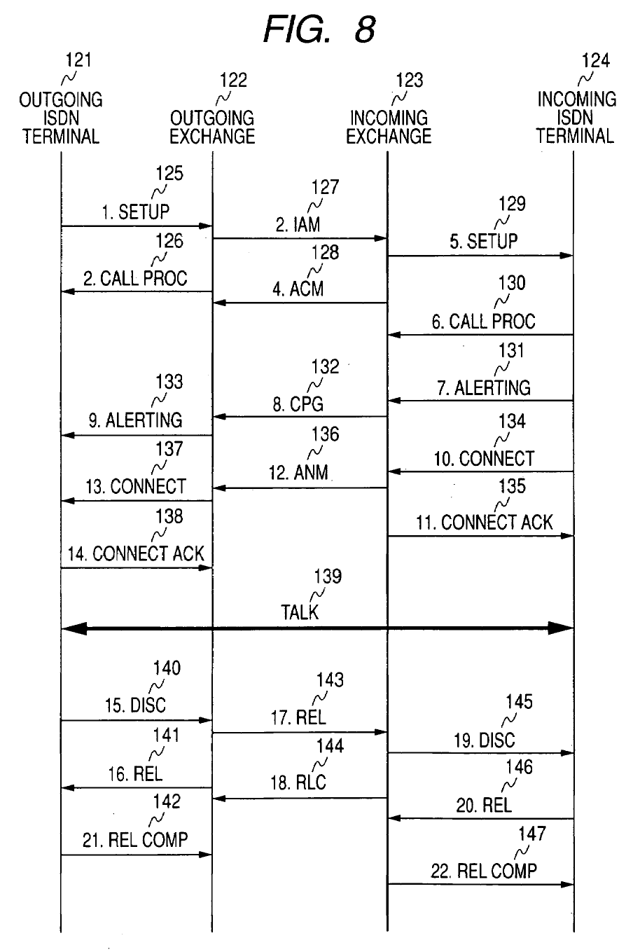

A specific example of the sequence from the outgoing call of step 95 to talking start 102 in FIG. 7, is shown by a step 125 to a step 138 of FIG. 8.

The sequence diagram of FIG. 8 is an ISDN subscriber signal diagram. Referring to FIG. 8, a trigger call signal acquired by the telephone adapter 61 will now be described.

In FIG. 8, first, when an outgoing ISDN terminal 121 makes a telephone call to an incoming ISDN terminal 124, in the step 125, a “SETUP” signal is transmitted to an outgoing exchange 122. The outgoing exchange 122, to notify an incoming exchange 123 thereof, then sends an “INITIAL ADDRESS MESSAGE” (hereafter, IAM) signal. In a step 126, a “CALL PROCEEDING (hereafter, CALLPROC)” signal showing that the “SETUP” signal was received is then transmitted to the outgoing ISDN terminal 121. Next, the incoming exchange 123 receives the “IAM” signal, in a step 129, sends a “SETUP” signal to notify an incoming call to the incoming ISDN terminal 124, and simultaneously sends an “ACM” signal to the outgoing exchange 122. The incoming ISDN terminal 124 receives the “SETUP” signal, and in a step 130, returns a “CALL PROC” signal which notifies receipt of “SETUP” to the incoming exchange 123. Next, the bell of the incoming ISDN terminal rings and the user is told that there is an incoming call. At the same time as the bell is rung, the outgoing ISDN terminal 121 is alerted by an “ALERTING” signal of a step 131, a “CALL PROGRESS MESSAGE (hereafter, CPG)” signal of a step 132, and an “ALERTING” signal of a step 133. Next, if the incoming ISDN terminal 124 picks up the receiver, in a step 134, a “CONNECT” signal is transmitted to the incoming exchange 123, in a step 136, the incoming exchange forwards this to the outgoing exchange 122 as an “ANSWER MESSAGE (hereafter, ANM)” signal, and a “CONNECT ACK” signal which shows that the “CONNECT” signal was received is sent to the incoming ISDN terminal 124 simultaneously. Also, in a step 137, the outgoing exchange 122 forwards the “ANM” signal to the outgoing ISDN terminal 121 as a “CONNECT” signal, the outgoing ISDN terminal returns a “CONNECT ACK” signal showing this was received to the outgoing exchange 122, and in a step 139, communication starts.

The outgoing ISDN terminal 121 of FIG. 8 may be considered as the telephone terminal 44 of User A in FIG. 7, and the outgoing exchange 122 of FIG. 8 may be considered as the PBX 55 in FIG. 7. The telephone adapter 61 is installed between the outgoing ISDN terminal 121 and the outgoing exchange 122 in FIG. 8, and receives call signals between them. The signal which shows that a call is starting in FIG. 8, is the “CONNECT” signal of step 137. Therefore, in the example of FIG. 7, the telephone adapter 61 determines reception of this “CONNECT” signal to be a trigger, and processing is then performed. In this specification, the trigger signal described was an ISDN subscriber signal, but the signal may be of any type provided that it shows that “a call is starting”. Also, the telephone adapter 61 receives call signals sent and received between the telephone terminal 44 of User A and PBX 55, which in the example FIG. 8 means all the signals in the step 12, step 126, step 133, step 137 and step 138, but for a signal other than a trigger, in the step 73 of the flow chart of FIG. 5, it is determined that “the signal is not a trigger signal”, processing is terminated, and the call signal is put through.

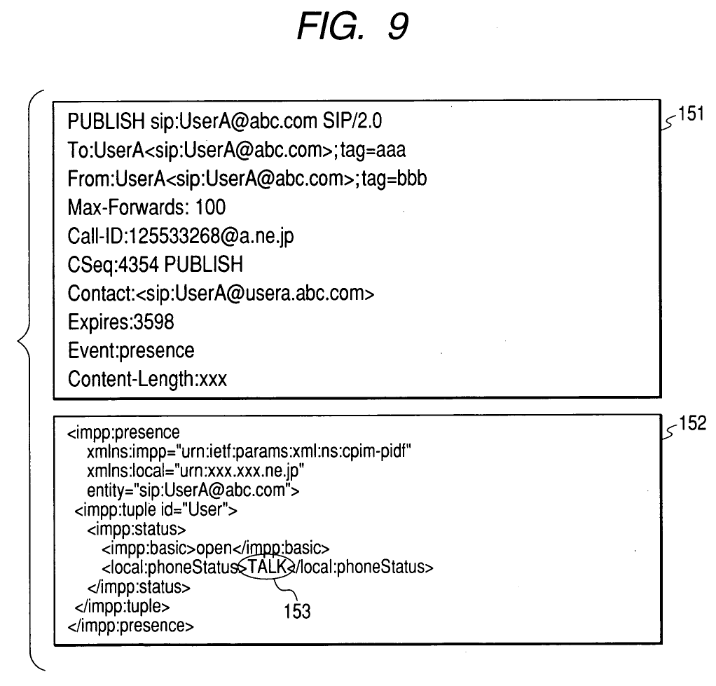

FIG. 9 shows an example where, in the step 103 of FIG. 7, the telephone adapter 61 displays a message showing that User A who sends a call to the presence send-receive server 52, is talking on the telephone. In this diagram, as an example, a SIP PUBLISH message and a PIDF presence data description for which standardization is being discussed by SIP WG and SIMPLE WG of IETF, are given. 151 of FIG. 9 is an example of a SIP message, and 152 is an example of a presence data description. In this message, for example, it is stated that the “phoneStatus” “is “talking on the telephone” as in 153, and the message is sent. Here, the case of SIP/SIMPLE was taken as an example, but the transmitted message may have any protocol or format.

Returning now to the sequence of FIG. 7, the presence send-receive server 52 which received the status of User A in the step 103, notifies that fact to the data terminal 47 of User B in a step 104. Due to this, User B is made aware that User A is talking on the telephone.

Next, in a step 105, the telephone terminal 44 of User A finishes the call, and in a step 106, sends a call end signal to the PBX 55. The telephone adapter 61 receives the signal in a step 107. The signal of the step 107 is a signal which shows “the time when the call finished”, and in a step 110, it is sent to the presence send-receive server 52 as presence data according to the processing of the flow chart of FIG. 5. In a step 108, the call signal is forwarded to the PBX 55 as it is, and in a step 109, the PBX 55 forwards the signal to the destination telephone terminal. Also, the presence send-receive server 52 which, in the step 110, became aware that there was a change in the presence data for User A, in a step 111, sends this information to the data terminal 47 of User B. Therefore, User B knows when User A finished his call, for example, if User B wishes to call User A but had to wait since User A was on the telephone, he can now call User A with the right timing.

Referring to the sequence diagram of the ISDN subscriber signal of FIG. 8, the signals from the step 106 to the step 109 of FIG. 7 will now be described.

In FIG. 8, when the telephone call of the step 139 is finished, the outgoing ISDN terminal 121, in a step 140, sends a “DISCONNECT (hereafter, DISC)” signal to the outgoing exchange 122. The outgoing exchange forwards the signal to the incoming exchange 123 by a “RELEASE (hereafter, REL)” signal of a step 143.

The “REL” signal is also returned to the outgoing ISDN terminal simultaneously, and the outgoing ISDN terminal returns a “RELEASE COMPLETE (hereafter, REL COMP)” signal to the outgoing exchange. When the incoming exchange receives the “REL” signal of the outgoing exchange, this signal is forwarded to the incoming ISDN terminal 124 by a “DISC” signal of a step 144. The incoming exchange, in the step 144, then returns a “RELEASE COMPLETE MESSAGE (hereafter, RLC)” signal. When the incoming ISDN terminal 124 receives the “DISC” signal, in a step 146, it returns the “REL” signal to the incoming exchange, and the incoming exchange, in a step 147, then returns a “REL COMP” signal to the incoming ISDN terminal. If the telephone terminal 44 of User A of FIG. 7 is regarded as the outgoing ISDN terminal 121 of FIG. 8, the telephone adapter 61 receives the signals of the step 140, step 141 and step 142, and the signal which shows “the time when the call finished” is the “DISC” signal of the step 140. Therefore, the telephone adapter 61 performs the processing of the flow chart of FIG. 5 using receipt of this “DISC” signal as a trigger. In this specification, the case where an ISDN subscriber signal was the trigger signal was taken as an example, but the signal type is not particularly limited provided that it is a signal which shows that “the call has finished” as with telephone call start.

The message which the telephone adapter 61 transmits to the presence send-receive server 52 in the step 110 when the telephone call is finished, is a message which describes the part 153 of FIG. 9 to be, for example, “on hold.”

The protocol and format of this message are also not particularly limited.

In Embodiment 1, the call signal is analyzed, so the status of various telephone terminals can be known by increasing the analysis patterns, and depending on the design, status other than the communication status of this example can be known.

### Embodiment 2

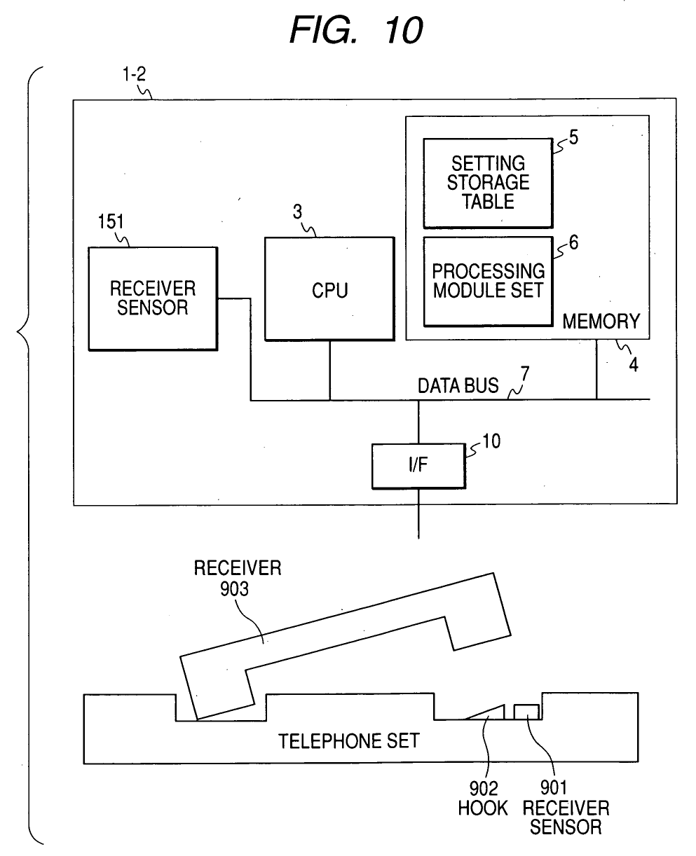

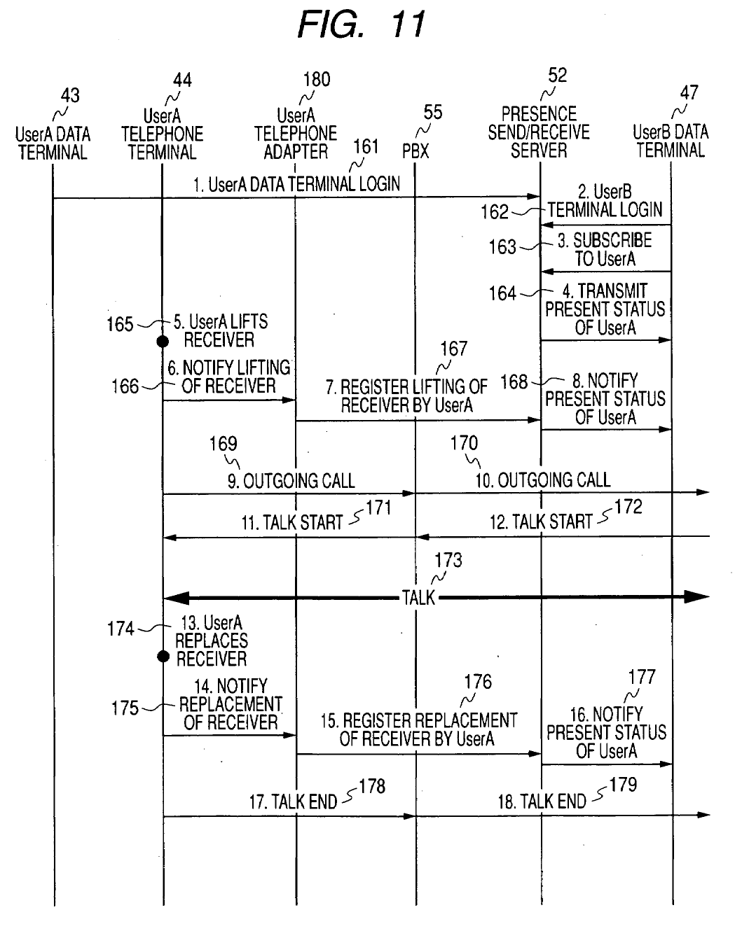

FIG. 10, FIG. 11 show an example where the example of FIG. 7 is implemented by a telephone adapter of different form. In this example, the telephone adapter is not activated by a trigger on reception of a call signal. As shown in the lower diagram of FIG. 10, a receiver sensor 901 is disposed near a telephone hook 92, the sensor perceiving an up-down motion of the hook due to a receiver 903, and a trigger is issued when the receiver moves up and down. The physical structure of the telephone adapter, together with this mechanism, is as shown in the upper diagram of FIG. 10. The difference from FIG. 1 is that, instead of the call signal processing unit 2, call signal IF (PBX side) 8 and call signal IF (terminal side) 9 of FIG. 1, a receiver sensor 151 is provided to handle the function of signal processing.

FIG. 11 is a sequence diagram of this example. The operation of this example will now be described following this sequence. A step 161 to a step 164 are identical to those of the example of FIG. 7. Subsequently, in a step 165, User A lifts the receiver of the telephone terminal 44 of User A to make an outgoing call to another user. The receiver sensor 901 attached near the hook then detects it, and processing by a telephone adapter 180 starts using this as a trigger. In a step 167, the telephone adapter 180 notifies the presence send-receive server 52 that the receiver was lifted. The presence send-receive server 52, in a step 168, then notifies this to the data terminal 47 of User B.

After lifting the receiver, in a step 169, User A makes an outgoing call to the other user, but in this example, the signal does not go through the telephone adapter 180.

The operation when the call ends is identical. When the User A, in a step 174, replaces the receiver of the telephone terminal 44, in a step 175, this is detected by the telephone adapter 180, in a step 176, this is transmitted to the presence send-receive server 52, and in a step 177, this is notified to the data terminal 47 of User B. The messages from the steps 176-177 are identical to those of the example of FIG. 7.

Hence, the telephone adapter of the invention may monitor the status of each user's telephone terminal not only by means of a call signal, but by other means. By using this other means, the status of a telephone terminal can be monitored without installing a function to analyze the call signal.

### Embodiment 3

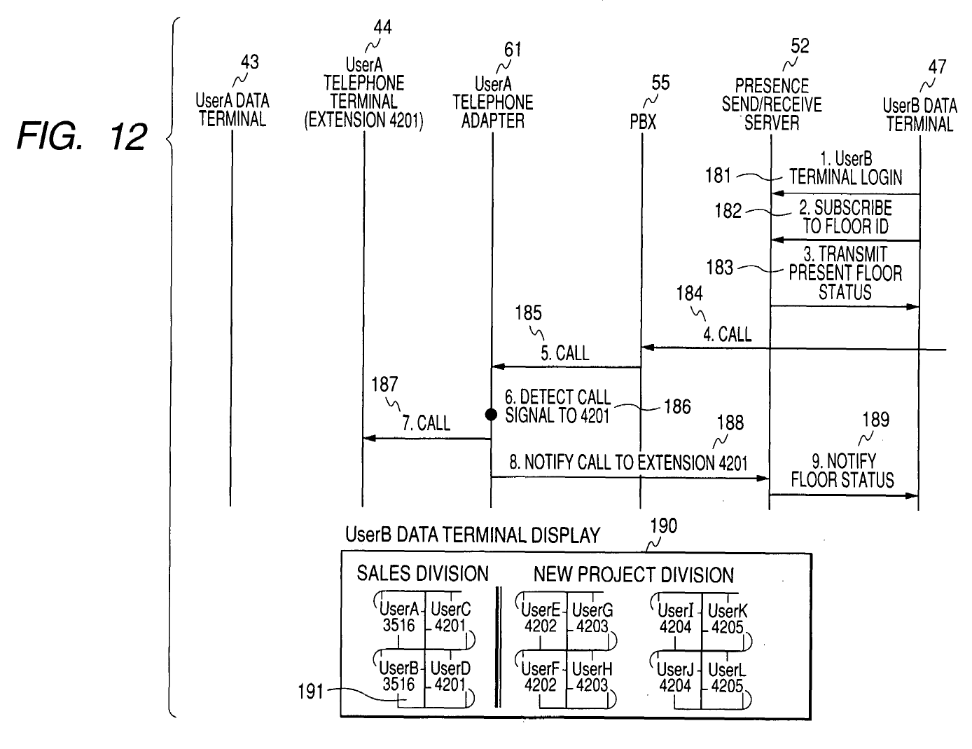

FIG. 12 is a sequence diagram showing a second application of the invention. FIG. 12 shows an example where, when there is a call to a telephone terminal managed by a telephone adapter, each telephone adapter sends this information to the presence send-receive server, and surrounding users can determine which telephone terminal bell is ringing. This example will now be described by following the sequence. This example applies to the network connections shown in FIG. 4. In this example, a trigger is generated from the call signal side as shown in FIG. 5, and the telephone adapter functions “when there is a telephone call”.

In this example, first in a step 181, the data terminal of User B logs in to the presence send-receive server 52. Next, it subscribes to its own floor ID. For example, if its location is 3F, Room No. 301, a subscription is made to this ID. It is thus possible to receive presence data as to the part where the telephone is ringing. Next, in a step 183, if the subscription is accepted by the presence send-receive server 52, the current status of the corresponding floor is sent to the data terminal 47 of User B.

Next, in a step 184, it is assumed that there was a call to the telephone terminal 44 of User A from outside. In a step 185, this signal is transmitted to the telephone adapter 61 of User A via the PBX 55. In a step 186, the telephone adapter 61 detects the call signal, determines that it is a trigger signal in the step 73 of the flow chart of FIG. 5, and then proceeds to the following step, so in a step 188, the fact that there was a call is transmitted to the presence send-receive server 52. Also, in a step 187, the received call signal is forwarded to the telephone terminal 44 of User A as it is. Subsequently, in a step 189, the presence send-receive server 52 notifies the data terminal 187 of User B that the telephone is ringing, and as a result, a display 190 of the data terminal of User B displays the part in which a telephone is now ringing as shown by 191.

In the example of the ISDN subscriber signal of FIG. 8, if the telephone terminal 44 of User A, which is the destination, is taken as the incoming ISDN terminal 124, the signal which shows that there is a telephone call is the “SETUP” signal of the step 129. However, as in the example of FIG. 7, the signal type is not limited if it is a signal corresponding to a call from the other party.

In Embodiment 3, it is easy to specify the original destination when making a proxy response or the like, and in this example, the telephone from which the call originated can be specified without putting a special function in the PBX.

### Embodiment 4

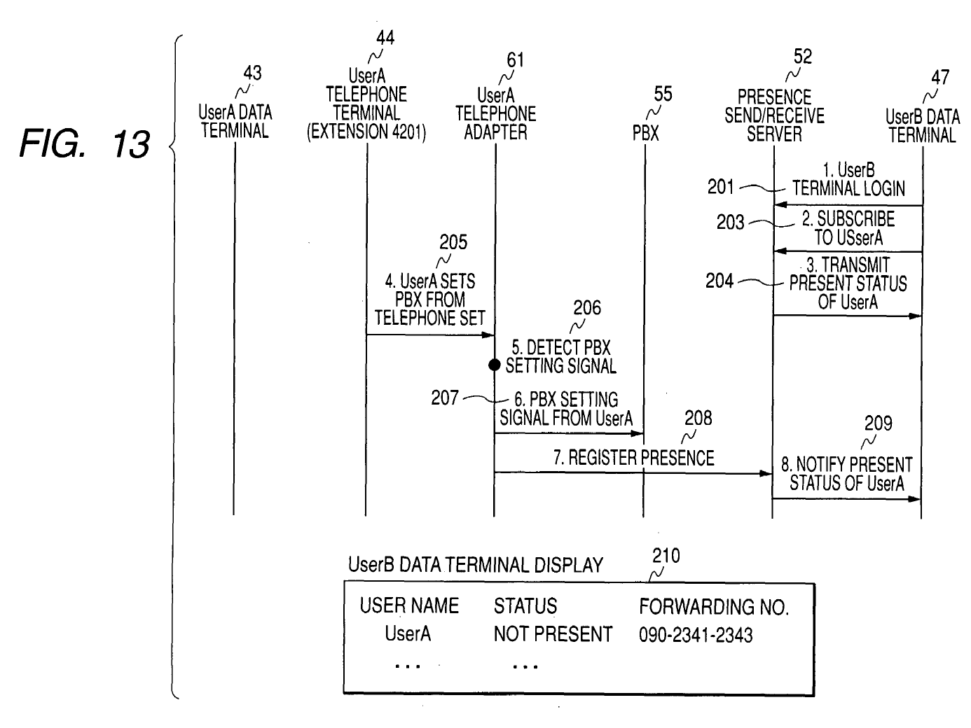

FIG. 13 is a sequence diagram showing a third application of the invention. FIG. 13 shows an example where, when each user makes a “not present” setting in the PBX (when a call is made to the target telephone, a “not present” notice is given by the PBX) from his own telephone terminal, or a forwarding setting (when a call is made to the target telephone, the outgoing call is forwarded to a different telephone terminal from the set number), the telephone adapter receives a signal and sends it to the presence send-receive server so that other users are notified of the telephone setting as presence information. This example will now be described referring to the sequence diagram. This example applies to the network connections shown in FIG. 4. It can be applied also to the network connections shown in FIG. 3, and in this case, as in the case of FIG. 7, the telephone adapter issues a setting request to a data terminal via a data signal line such as USB or the like, messages actually being sent to and from the presence send-receive server by the data terminal. In this example, a trigger is generated from the call signal side as shown in FIG. 5, and the telephone adapter functions “when the telephone terminal makes a setting in the PBX”.

In this example, first, in the operations from a step 202 to a step 204, the data terminal 47 of User B logs in to the presence send-receive server 52. This sequence is identical to the steps 92 to 94 of FIG. 7. Next, in a step 205, User A performs a telephone setting in the PBX 55 from the telephone terminal 44. The telephone adapter 61 of user A detects this signal in a step 206. Next, in the step 72 of FIG. 5, it is determined that this is a trigger call signal, and in a step 208, the telephone terminal 44 registers presence data in the presence send-receive server 52 according to the details set on the PBX 55. For example, when making a “not present” setting, presence data stating that the current status of User A is “not present” is registered, and when User A makes a setting to cancel the “not present” telephone setting, presence data stating that the current status of User A is “present” is registered. Next, in a step 209, the fact that the current status of User A has changed is notified to the data terminal 47 of User B. As a result, the status of User A is displayed on a display 210 of the data terminal of User B. For example, when User A makes a call forwarding setting, it is displayed that User A is “not present” and that calls will be forwarded to “090-2341-2343” as shown in FIG. 13.

In Embodiment 4, each user can also update the data system settings automatically simply by setting the telephone exchange using a telephone terminal.

### Embodiment 5

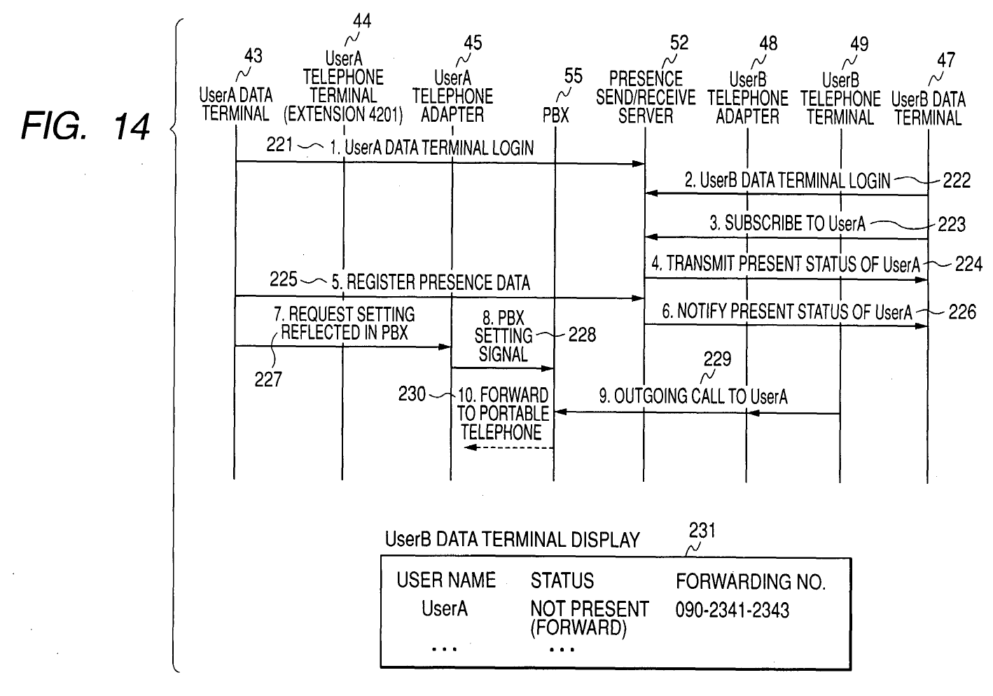

FIG. 14 is a sequence diagram showing a fourth application of the invention. FIG. 14 is an example where, when each user registers presence data in the presence send-receive server from his own data terminal, the data terminal sends a signal to the telephone adapter, and as a result, the telephone adapter makes a telephone setting in the PBX by a call signal according to the presence information set by the data terminal. This example will be described referring to the sequence diagram. This example applies to the network connections shown in FIG. 3. In this example, a trigger is generated from the data terminal side as shown in FIG. 6, and the telephone adapter functions “when the data terminal has requested a setting by a call signal”.

In this example, first, from a step 221 to a step 224, the data terminal 43 of User A and the data terminal 47 of User B log in to the presence send-receive server 52, and the data terminal 47 of User B also acquires presence data for User A. This sequence is identical to the sequence from the step 91 to the step 94 of FIG. 7. Next, in a step 225, User A registers presence information in the presence send-receive server 52 from the data terminal 43 of User A. This data, in a step 226, is naturally notified to the data terminal 47 of User B from the presence send-receive server 52. The display of the data terminal of User B is therefore as shown by 231, and in a step 227, the data terminal 43 of User A issues a request to make an identical setting in the telephone adapter 45 of User A and the PBX. The telephone adapter 45 then executes the flow chart of FIG. 6, determines that this is an outside message which is a trigger in the step 83, and performs subsequent processing. In a step 228 of FIG. 14, it issues a call signal to the PBX 55 instead of the telephone terminal 44, and the PBX 55 updates the setting of the telephone terminal 44. For example, if User A sets the current status to “not present (forwarding)” in the presence send-receive server 52, the telephone adapter 45 makes a telephone forwarding setting in the PBX 55 accordingly. As a result, if in a step 229, User B makes an outgoing call to User A, the PBX 55 forwards the outgoing signal to the forwarding telephone number of User A as in a step 230.

In Embodiment 5, each user can also update the setting of the PBX automatically by making a data setting in the presence server using a data terminal.

### Embodiment 6

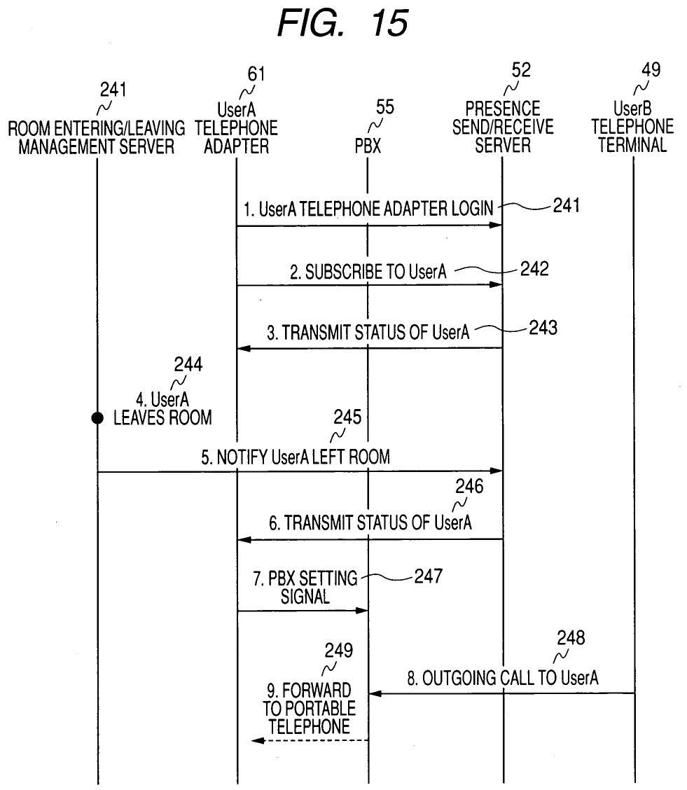

FIG. 15 is a sequence diagram showing a fifth application of the invention. In FIG. 15, the telephone adapter of User A monitors his current status. If, for example, User A leaves his room, when this fact is detected by another device such as a sensor or the like, this is notified to the telephone adapter of User A as presence data, and as a result, the telephone adapter makes a “not present” setting or a “forwarding” setting in the PBX. In this example, the network connections are as shown in FIG. 4. In this example, a trigger is generated from the IP network side as shown in FIG. 6, and the telephone adapter functions “when the status of the target user has changed to a given status”.

In this example, first, from a step 241 to a step 243, the data terminal 43 of User A logs in to the presence send-receive server 52 and acquires presence data for User A. This sequence is identical to the sequence from the step 91 to the step 94 of FIG. 7. Next, in a step 244, a server which monitors the arrival and departure of staff members detects that User A has left, and in a step 245, notifies that fact to the presence send-receive server 52. The presence send-receive server 52 notifies the telephone adapter 61 of User A, which subscribes to User A, that User A has left the room. The telephone adapter 61 then executes the flow chart of FIG. 6, determines that this is an outside message which is a trigger in the step 83, and performs subsequent processing. In a step 247 of FIG. 15, it issues a call signal to the PBX 55 instead of the telephone terminal 44, and the PBX 55 updates the setting of the telephone terminal 44 of User A. For example, when it is notified by the presence send-receive server 52 that User A has left the room, the telephone adapter 61 performs a telephone forwarding setting in the PBX 55 accordingly. As a result, when User B makes an outgoing call to User A in a step 248, the PBX 55 forwards the outgoing signal to the forwarding number of User A as in the step 249.

In Embodiment 6, by monitoring the status of the presence send-receive server, telephone settings can be updated by presence data which has been automatically registered by a sensor or the like. The sensor acquires information without each user being aware of it, and sends this status to the presence send-receive server. Therefore, each user can make telephone settings in the PBX without consciously making the settings himself.

### Embodiment 7

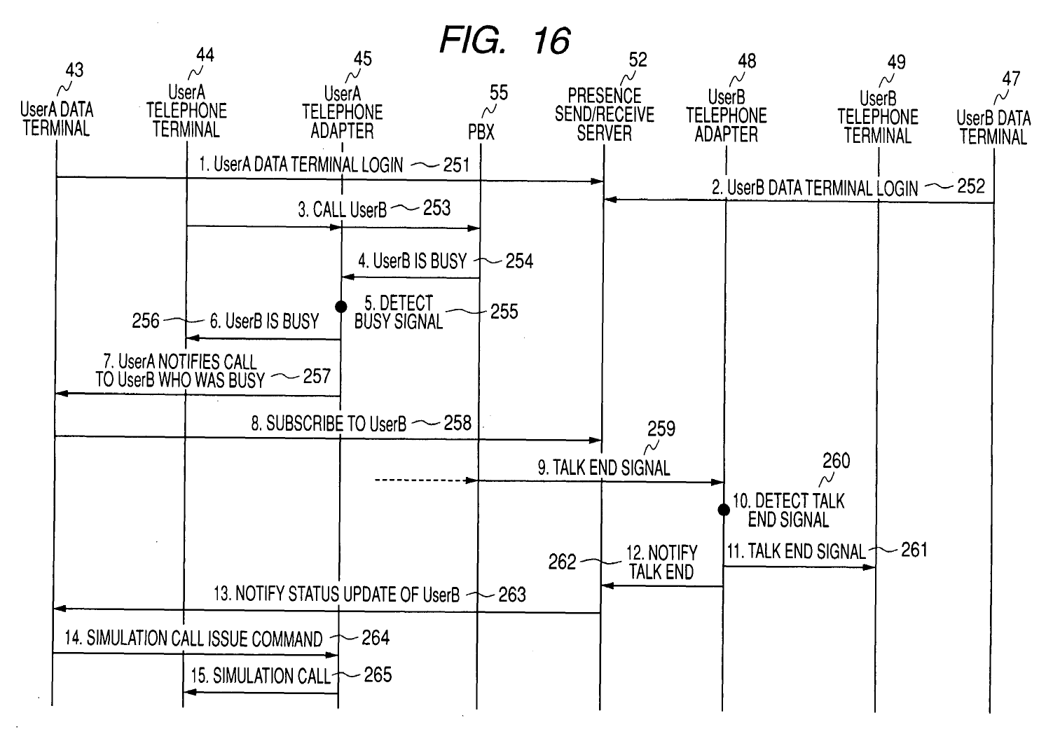

FIG. 16 is a sequence diagram showing a sixth application of the invention. FIG. 16 shows a case where User A makes an outgoing call to User B, but if the other party is busy, this fact is notified to a data terminal, and the data terminal acquires the presence status of User B. When User B's call finishes and a notification to this effect is received, a request is issued to make a simulation call to the telephone adapter, and due to this processing, the fact that User B's call has finished is notified using a telephone terminal. This example applies to the network connections shown in FIG. 3. However, it can be applied even in the case of the network connections shown in FIG. 4. In this case, the telephone adapter itself acquires the presence status of User B, and when User B's call is finished, determines to make a simulation call itself. In this example, a trigger is generated from the call signal side as shown in FIG. 5, and the telephone adapter functions “when a busy signal is received”. A trigger is also generated from the data terminal side as shown in FIG. 6, and the telephone adapter then functions “when a simulation call request is received”.

In this example, first, from a step 251 to a step 252, the telephone adapters of User A, User B log in to the presence send-receive server 52, respectively. The login is identical to the example of FIG. 7. Next, in a step 253, User A makes an outgoing call to User B using the telephone terminal 44. Now assume that User B is currently busy, and in a step 254 and PBX 55 has returned a signal to the effect that User B is busy. The telephone adapter 45 receives this signal in a step 255, executes the flow chart of FIG. 5, determines that this is a trigger call signal in the step 73, and performs processing. As a result, in a step 257, the data terminal 43 of User A is notified that User A telephoned User B, but the line was busy. The data terminal 43 receives this notification, and in a step 258, to monitor the end of User B's call, sends a subscribe message to the presence send-receive server 52 showing that it wishes to acquire presence data for User B. Next, assume that in a step 259, User B finishes his call. At this time, in a step 260, the telephone adapter 48 of User B receives the signal of the step 259, starts the processing of the flow chart of FIG. 5, and as a result, in a step 262, the presence send-receive server 52 is notified that the call has finished. A call end call signal is then forwarded to the telephone terminal 49 of User B from the telephone adapter 48 as it is, as in the step 261. The presence send-receive server 52 receives the notification from the telephone adapter 48, and in a step 263, this fact is notified to the data terminal 43 of User A. The data terminal 43 which received the notification, in a step 264, issues a request to make a simulation call to the telephone adapter 45 of User A. As a result, the telephone adapter 45, by making a simulation call to the telephone adapter 44 of User A, notifies User A by means of a sound that User B's call has finished.

As in this example, the telephone adapter can also be used as a means of notifying that the presence data has been updated. If the user desires to know that the presence data has changed as soon as it changes, however many messages may be shown on the display of the data terminal, the user cannot be made aware of this fact unless he looks at the display. However, by giving an audible notification by ringing a telephone, presence changes can be notified more reliably.

### Embodiment 8

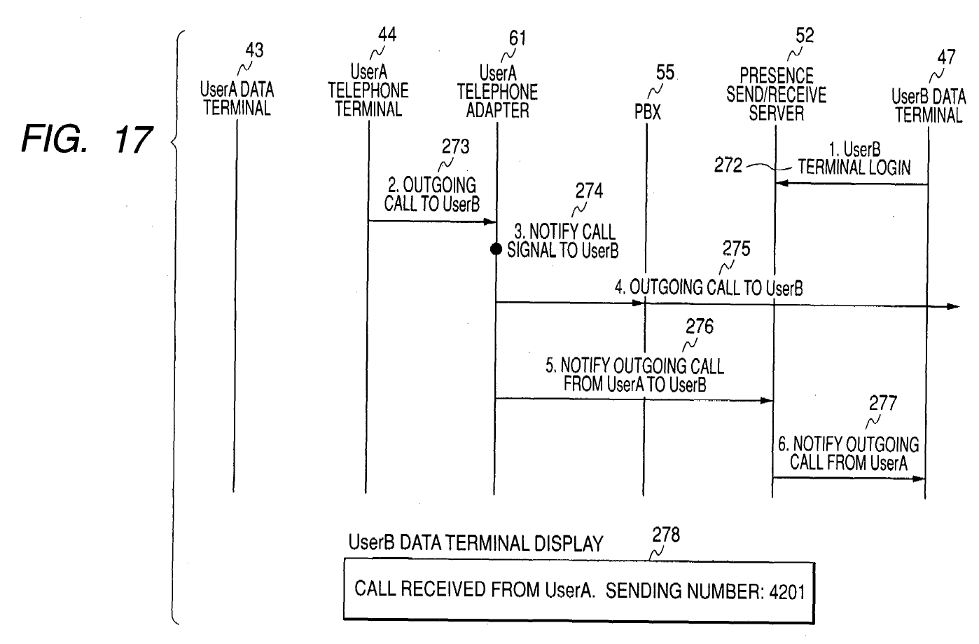

FIG. 17 is a sequence diagram showing a seventh application of the invention. FIG. 17 is an example where, when User A makes an outgoing call to User B, the telephone adapter of User A notifies this fact to the presence send-receive server and this is notified to the data terminal of User B. Hence, User B can determine from whom the call to User B was made, i.e., this is equivalent to providing the telephone adapter with a “number display” function. By combining a telephone adapter with a data terminal, the same function as that of a number display can be implemented even on a telephone without a number display function. This example applies to the network connections shown in FIG. 4. However, it can also be implemented with the network connections shown in FIG. 3. In this case, as in the case of FIG. 7, the telephone adapter issues a setting request to the data terminal via a data signal line such as USB or the like, actual message sending/receiving to and from the presence send-receive server being performed by the data terminal. In this example, a trigger is generated from the call signal side as shown in FIG. 5, and the telephone adapter functions “when an outgoing call is received”.

In this example, first, in a step 272, the data terminal of User B logs in to the presence send-receive server. The sequence at this time is identical to that of FIG. 7. Next, in a step 273, when the telephone terminal 44 of User A makes an outgoing call to User B, in a step 274, the telephone adapter 61 of User A receives this signal, starts the processing of the flow chart of FIG. 5 and determines that this is a trigger call signal in the step 73. In subsequent processing, in a step 276, the fact that User A is calling User B is notified to the presence send-receive server 52. In a step 277, the presence send-receive server 52 notifies this fact to the data terminal of User B, and as a result, the display of the data terminal of User B shows that a call is being made by User A.

The essential feature of this embodiment is that a number display function can be implemented in a PBX without actually introducing such a function.

### Embodiment 9

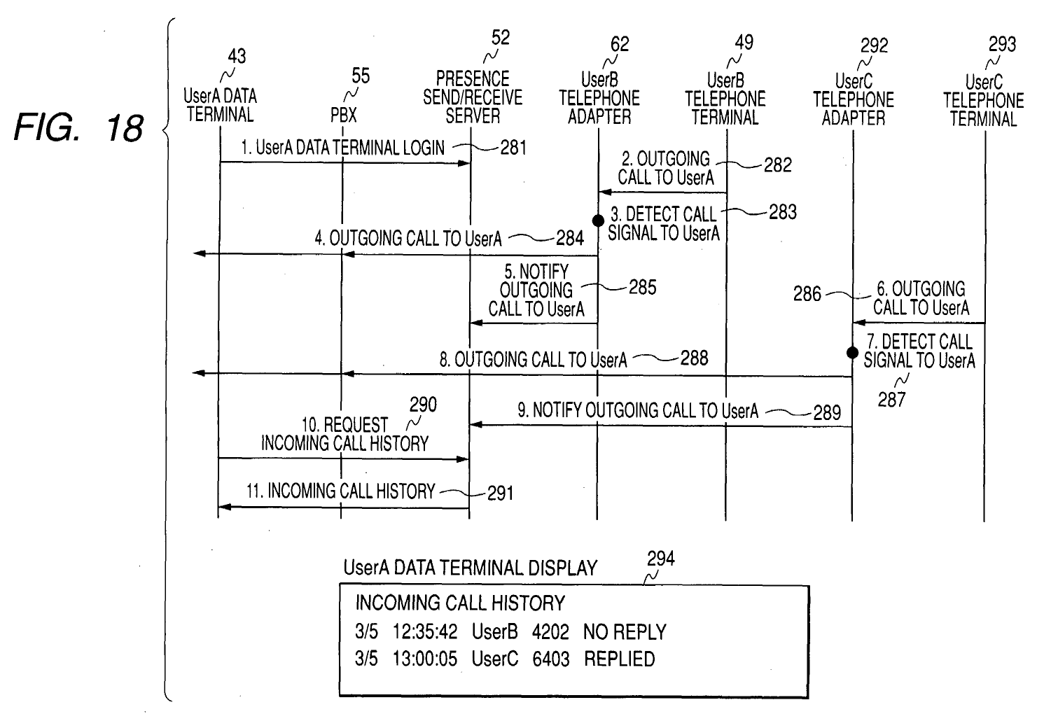

FIG. 18 is a sequence diagram showing an eighth application of the invention. FIG. 18 is an example where a telephone adapter of another user who made a call to User A is registered by the presence send-receive server, and an incoming call history is displayed when User A confirms this data. This example applies to the network connections shown in FIG. 4. However, it can be implemented also with the network connections shown in FIG. 3. In this case, the telephone adapter sends an outgoing call history registration request to a data terminal via a data signal line such as USB or the like, communication with the presence send-receive server actually being performed by the data terminal. In this example, the history is sent and received using the presence send-receive server, but it can be performed by another server provided that it has an identical function. In this example, a trigger is generated from the call signal side as shown in FIG. 5, and the telephone adapter functions “when an outgoing call is received”.

In this example, first, in a step 281, the data terminal 43 of User A logs into the presence send-receive server 52. This operation is identical to the login of the case of FIG. 7. Next, in a step 282, assume that the telephone terminal 49 of User B has made an outgoing call to User A. In a step 283, the telephone adapter of User B receives the call signal, starts the processing of the flow chart of FIG. 5, and determines that this is a trigger call signal in the step 73. In subsequent processing, the fact that User B made an outgoing call to User A is registered in the presence send-receive server 52. Also, in a step 284, a telephone adapter 62 forwards the received call signal to the PBX 55 as it is. Next, in a step 286, assume that User C has made an outgoing call to User A using the telephone terminal 293. In the same way as that of User B, in a step 287, the telephone adapter 292 of User C receives this call signal, in a step 289, the fact that User C made an outgoing call to User A is registered in the presence send-receive server 52, and in a step 288, the call signal is forwarded as it is. Next, in a step 290, User A uses the data terminal 43 to access the presence send-receive server 52, and when he tries to acquire his own incoming call history, in a step 291, a response is returned as shown by 294 on the display of the data terminal.

In this example, the telephone adapters installed on the User B, User C outgoing call sides register outgoing call records in User A, but conversely, the telephone adapter of User A can register the incoming call history from User B, User C.

The main feature of this embodiment is that outgoing/incoming call history checks such as those provided by IP telephone (soft phone) can be implemented on a PC even using a prior art PBX and an ordinary telephone.

What is claimed is:

1. A communication controller connected with a telephone terminal and a communication control unit, said controller comprising:
a receiving unit which receives communication data between said telephone terminal and said communication control unit; and
a control unit which analyzes this communication data, acquires the status of said telephone terminal, and notifies this status to another communication device.

2. The communication controller according to claim 1, wherein, instead of analyzing said communication data, the status of said telephone terminal is acquired by detecting at least one physical operation among the raising or lowering of the receiver of said telephone terminal, or the depression of a button.

3. The communication controller according to claim 1, wherein said other device is a data terminal, and said notification is performed via a signal line which connects said data terminal and this communication control unit.

4. The communication controller according to claim 1, wherein said other communication device is a server, and said notification is performed via a signal line which connects said server and this communication control unit.

5. The communication controller according to claim 1, wherein the status of said telephone terminal is the communication status of this telephone terminal.

6. The communication controller according to claim 1, wherein the status of said telephone terminal is an up/down status of a hook of this telephone terminal.

7. The communication controller according to claim 1, wherein the status of said telephone terminal is at least one of the status of the outgoing call from this telephone terminal, outgoing call destination data, outgoing call source data, status of incoming calls to this telephone terminal, incoming call destination data and incoming call source data.

8. The communication controller according to claim 1, wherein the status of said telephone terminal is a setting performed by this telephone terminal in said communication control unit.

9. The communication controller according to claim 1, wherein the status of said telephone terminal is a busy response to an outgoing call of this telephone terminal.

10. A communication controller connected to a telephone terminal, comprising:
a receiving unit which receives a signal from a device other than this telephone terminal; and
a control unit which sends a call signal based on this signal.

11. The communication controller according to claim 10, wherein the device other than said telephone terminal is a data terminal connected to this communication control unit by a signal line.

12. The communication controller according to claim 11, wherein the device other than said telephone terminal is a server connected to this communication control unit by a network signal line.

13. The communication controller according to claim 12, wherein the controller determines an appropriate action based on a signal received from said server prior to sending said call signal.

14. The communication controller according to claim 10, wherein the destination of said call signal is a communication control unit.

15. The communication controller according to claim 10, wherein the destination of said call signal is said telephone terminal.

16. The communication controller according to claim 10, wherein the destination of said call signal is both said telephone terminal and said communication control unit.

17. The communication controller according to claim 10, wherein the signal from a device other than said telephone terminal is a telephone setting request to said communication control unit.

18. The communication controller according to claim 10, wherein the signal from a device other than said telephone terminal is presence data transmitted from a server.
